(19) United States
(12) Patent Application Publication
(10) Pub. No.: US 2003/0213065 A1
(43) Pub. Date: Nov. 20, 2003

(54) Bed for long-stay patients

(76) Inventor: Elena Bristotti, Genova (IT)

Correspondence Address: LARSON & TAYLOR, PLC, 1199 NORTH FAIRFAX STREET, SUITE 900, ALEXANDRIA, VA, 22314, US

(21) Appl. No.: 10/440,150

(22) Filed: May 19, 2003

(30) Foreign Application Priority Data
May 17, 2002 (IT) GE2002 A 000042

(51) Int. Cl. A61G 7/02; A61G 7/015

(52) U.S. Cl. 5/604; 5/617

(57) ABSTRACT

Bed for long-stay patients, in particular for bedridden patients suffering from bedsores, comprising a metal frame supporting a support platform for a mattress, characterized in that said mattress consists of a plurality of independent sections, each of them being firmly connected to a frame peripherally protruding from said support platform.

### BACKGROUND AND SUMMARY OF THE INVENTION

The present invention relates to a bed for long-stay patients, in particular for bedridden patients suffering from bedsores. According to one of its features said bed comprises a metal frame supporting a support platform, either with sprung bed base or staves, on which lies a mattress consisting of a plurality of independent sections, each of them being firmly connected to a frame peripherally protruding from said support platform. Advantageously, said support platform is equipped with an articulated joint placed in the central portion of the bed, so as to lift in a sub-vertical position the bed portion against which the patient's back rests, so as to let the patient be sitting. A similar articulated joint can be provided in the portion corresponding to the patient's legs so as to lift the latter, if necessary, thus helping venous circulation. Said movements can be carried out manually or easily thanks to suitable electric motors operated with a remote control. Advantageously, the bed is equipped with a commode and is mounted on gummed wheels, thus making it easy to move.

### BRIEF DESCRIPTION OF THE DRAWINGS

Further characteristics and advantages of the bed according to the invention shall be evident from the following description of a preferred embodiment of the latter, given as mere non-limiting example, shown in the appended drawings, in which:

FIG. 1 is a view in side elevation, partially sectioned according to the plane of line I-I of FIG. 2, and

FIG. 2 is a plan view of the bed of FIG. 1.

### DESCRIPTION OF THE PREFERRED EMBODIMENTS OF THE INVENTION

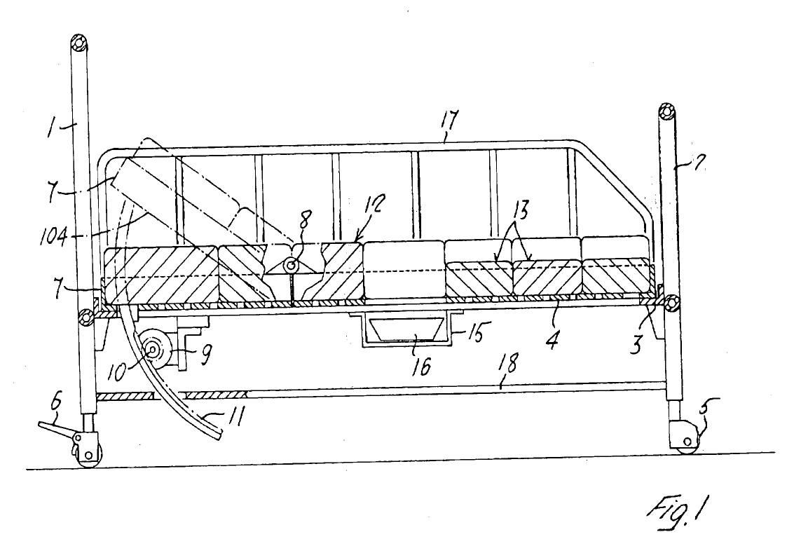

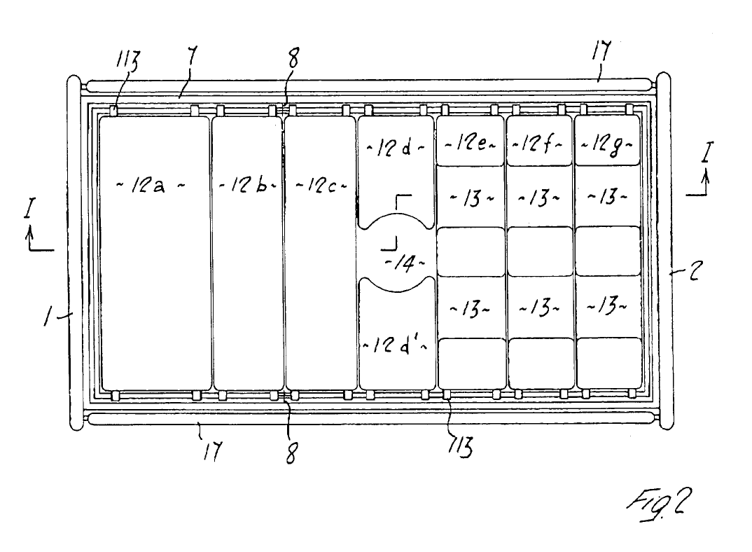

With reference to the drawings, the bed shown comprises—in a wholly usual way—a head portion 1 and a foot portion 2, which are advantageously made of metal tubes and connected one to the other by means of a metal frame 3 supporting a sprung base or a stave structure 4 constituting the support platform for the bed mattress. The four feet of the bed are mounted on castor gummed wheels 5, said feet being equipped with braking means 6 for blocking said wheels, so as to prevent the bed from moving in undesired directions. The support platform 4 for the mattress is provided on its whole perimeter with an edge 7 constituting a peripheral frame protruding above, and said support platform 4 is articulated around the pins 8, which are basically positioned in the area where the patient's pelvis rests, so as to lift the portion 104 of the support platform 4 on which the patient's back lies, in a sub-vertical position, as shown in FIG. 1 with dots and lines. To this purpose it can be provided for a motorized lifting system comprising a motor 9 equipped on its shaft with a pinion 10 engaging with a rack portion of a circular sector 11, connected to said portion 104, so as to lift and/or lower the latter by means of a suitable remote control (not shown). A similar device can be provided in the portion corresponding to the patient's legs so as to lift the latter. Above the support platform 4 lies the mattress 12. As better shown in FIG. 2, said mattress 12 is divided into a series of independent cross sections which, in the case shown, have been referred to as 12a, 12b, 12c, 12d, 12d′, 12e, 12f, 12g. Obviously, there could be more or less of said sections than those shown. Said mattress sections are firmly secured to the edges 7 for instance by means of pins with a butterfly screw 113, or by means of any other suitable device. This division into independent portions of the mattress 12 further allows to choose for every bed portion the padding material having the best thickness for supporting the patient. Moreover, as shown, the mattress sections 12e to 12g, can be advantageously provided on both sides with hollows 13 housing the patient's legs. Eventually, in the central portion the mattress sections 12d and 12d′ are separated by a wide circular passage 14 communicating with the compartment below 15 (see FIG. 1) housing a hygienic bedpan 16. The bed here described is eventually equipped with two side edges 17 secured to the bed structure in any suitable way, and with a platform 18 arranged close to the bed base, which can be used as a generic support platform.

Obviously, although the bed has been described as being made of metal tubes, it can also be carried out with other materials, wood for instance. The support platform 18 can advantageously be made by a light material and be placed some centimeters below the support platform 15 for the hygienic receptacle 16. Said support platform can be used for putting away various items such as drug basins, and so on.

The peripheral bed-side 7 shall have such a height as to contain the mattress 12, and its height shall preferably be a little smaller than the thickness of the mattress 12. This edge prevents the mattress from slipping.

Thanks to the wheels 5 the bed can be shifted as the patient desires, and for instance before a window, and so on.

The bed described can also be provided with a washable ring-shaped cushion, to be used as a soft sitting support.

Moreover, the circular passage 14 can be equipped with a closing element.

I claim

1. Bed for long-stay patients, in particular for bedridden patients suffering from bedsores, comprising a metal frame supporting a support platform for a mattress, in which said mattress is formed by a plurality of independent sections, each of them being firmly connected to a frame peripherally protruding from said support platform.

2. Bed according to claim 1, in which the said support platform consists of a sprung bed base or of a stave structure.

3. Bed according to claim 1, in which said support platform is equipped with an articulated joint arranged in the central bed portion, so as to lift in a sub-vertical position the bed portion against which the patient's back rests.

4. Bed according to claim 1, in which said support platform is provided with an articulated joint in the portion corresponding to the patient's legs.

5. Bed according to claim 4 in which said lifting and/or lowering movements of the portions concerned of said support platform can be carried out with suitable motors.

6. Bed according to claim 1, further equipped with a compartment housing a bedpan below the said support platform, the said support platform and the said mattress being provided with a hole communicating with the compartment housing the said bedpan.

7. Bed according to claim 1, further provided with castor gummed wheels, equipped with blocking elements.

8. Bed according to claim 1, in which said mattress is divided into a series of independent cross sections each secured to the bed-side of the support platform for instance by means of pins.

9. Bed according to claim 8, in which for each mattress section it is possible to choose the padding material having the best consistency for supporting the patient.

10. Bed according to the claim 9, in which the mattress sections placed close to the patient's legs can be advantageously provided on both sides with hollows housing the patient's legs.

11. Bed according to claim 1, further equipped with side edges secured to the bed structure in an easily removable way.

12. Bed according claim 1, further comprising a platform arranged close to the bed base, which can be used as a generic support platform.
